(19) United States
(12) Patent Application Publication
(10) Pub. No.: US 2007/0144481 A1
(43) Pub. Date: Jun. 28, 2007

(54) Method for controlling the compression ignition mode of an internal combustion engine

(76) Inventors: Mirko Ciecinski, Weissach im Tal (DE); Rudiger Herweg, Esslingen (DE); Matthias Pfau, Ludwigsburg (DE); Jochen Schaflein, Stuttgart (DE)

Correspondence Address: KLAUS J. BACH, 4407 TWIN OAKS DRIVE, MURRYSVILLE, PA, 15668, US

(21) Appl. No.: 11/650,591

(22) Filed: Jan. 5, 2007

Related U.S. Application Data
(63) Continuation-in-part of application No. PCT/EP05/06786, filed on Jun. 23, 2005.

(30) Foreign Application Priority Data
Jul. 7, 2006 (DE) 10 2004 032 986.9

(51) Int. Cl. F02B 3/00; F02D 41/00; G06F 17/00

(52) U.S. Cl. 123/299; 701/104; 123/679; 701/109

(57) ABSTRACT

In a method for controlling a reciprocating piston internal combustion engine having a plurality of cylinders in a compression ignition operating mode in which a lean fuel/air mixture is burnt, wherein an actual value of at least one characteristic variable which is influenced by the fuel burning process is compared with a pre-definable set point value in order to form a control value, with which the setting of an operating parameter affecting the mixture formation is adjusted in order to approximate the actual value of the characteristic variable, in a first control circuit, a mean value of the characteristic variable is determined and adjusted to an overall set point value using the control value, which is supplied to all the cylinders, and, in a second control circuit, characteristic variables which are measured at each cylinder are matched by means of individually determined control values in order to ensure a stable combustion in the compression operating mode.

This is a Continuation-In-Part application of pending international patent application PCT/EP2005/006786 filed Jun. 23, 2005 and claiming the priority of German patent application 10 2004 032 986.9 filed Jul. 8, 2004.

### BACKGROUND OF THE INVENTION

The invention relates to a method of operating an internal combustion engine with a plurality of cylinders in a compression ignition operating mode wherein a fuel/air mixture is burnt and a variable affected by the burning of the fuel is compared with a set point value to form a variable with which the setting of the operating parameter is adjusted in order to approximate the actual value of the variable.

The mode of operation of an internal combustion engine which is referred to as compression ignition or chamber ignition provides the possibility of fuel combustion for driving the internal combustion engine with a good thermal efficiency and low nitrogen oxides formation as a result of the combustion of relatively lean fuel/air mixtures in the cylinders of the internal combustion engine. The mixture is raised to a relatively high temperature level by adding combustion exhaust gases, and as a result the mixture is made to auto-ignite during the compression of the next working cycle of the respective cylinder. In a gasoline engine, a spark ignition operating mode is usually provided for at high load ranges of the internal combustion engine. The raising of the temperature in order to trigger the compression ignition is usually brought about by retaining exhaust gases in the cylinders, for which a corresponding setting of the valve closure overlap the control times by the gas exchange valves is provided, and exhaust gases are retained in the combustion chamber by correspondingly closing the outlet valve.

The start and the profile of the combustion process is sensitive in the compression ignition mode and uncontrolled auto-ignitions cause undesirably early combustion and high pressures in the combustion chamber, which interferes with optimum combustion. DE 102 15 674 A1 provides, for the purpose of improving and checking the combustion behavior of the internal combustion engine, a method for controlling the compression ignition mode in which an actual value of a characteristic variable which is influenced by the fuel combustion process is measured and is adjusted to a predefined set point value by changing an operating parameter for changing the mixture formed in the combustion chamber.

In the known method, the position of a 50% mass conversion point of the fuel conversion during the combustion, also referred to as center point of the combustion, is determined as a characteristic variable of the combustion process, for example from the measurement signal of an ion current probe which projects into the combustion chamber or a pressure sensor which is arranged in the combustion chamber. If the mass conversion point which is determined deviates from the predefined set point value, the actual value in the control circuit of the known method is approximated by varying the valve control times and/or a fuel injection strategy. The variation of the valve control times is intended to be performed in the known method by means of cam shaft adjusters, and alternatively the valve control times are varied by an electromagnetic valve controller or other variable valve control devices. For this purpose cam shafts with phase adjusters or switchable bucket tappets with a variable valve stroke limitation are proposed. In order to adapt the characteristic variable by changing the injection parameters the time of the fuel injection or the period of the injection or the injected fuel quantity or, if appropriate, the timing of the fuel injection is modified.

WO 99/42718 discloses a method for controlling the compression ignition mode in which the start of the combustion process is determined by means of a pressure sensor which projects into the combustion chamber. The operation of the internal combustion engine is monitored at this continuously measurable characteristic variable by controlling the engine temperature, the pressure or also the mixture properties or the excess air factor in the exhaust gas.

However, the known control methods often do not meet the extremely stringent requirements of the combustion behavior during operation of the internal combustion engine with compression ignition, which is sensitive and difficult to monitor.

It is the object of the present invention to provide a method for controlling a multi-cylinder reciprocating piston internal combustion engine in a compression ignition operating mode in such a way that uncontrolled auto-ignitions and fuel combustion processes are avoided.

### SUMMARY OF THE INVENTION

In a method for controlling a reciprocating piston internal combustion engine having a plurality of cylinders in a compression ignition operating mode in which a lean fuel/air mixture is burnt, wherein an actual value of at least one characteristic variable which is influenced by the fuel burning process is compared with a pre-definable set point value in order to form a desired value, with which the setting of an operating parameter affecting the mixture formation is adjusted in order to approximate the actual value of the characteristic variable, in a first control circuit, a mean value of the characteristic variable is determined and adjusted to an overall set point value using the desired value, which is supplied to all the cylinders, and, in a second control circuit, characteristic variables which are measured at each cylinder are matched by means of individually determined desired values in order to ensure a stable combustion in the compression operating mode.

According to the invention, two control circuits are provided. A mean value, influenced by all the cylinders, of a characteristic variable is measured in a first control circuit and is adjusted to an overall set point value with a manipulated variable which is fed to all the cylinders. In the second control circuit, characteristic variables which are measured at each cylinder are matched to one another by means of individually determined manipulated variables. After the actuating measures within the scope of the first control circuit, an actual combustion behavior which deviates more or less from the optimum combustion behavior and causes faulty results may occur with the operating parameter which is applied at individual cylinders. Such deviations can occur, for example, due to different wear states of the cylinders. With the second control circuit according to the invention, small deviations from the optimum setting which possibly occur are compensated for.

In the second control circuit, a set point value for the individual approximation of the measured characteristic variables of the respective cylinders is advantageously provided, said set point value being available from a characteristic diagram memory for retrieval as necessary. However, the average value of the measured characteristic variables of all the cylinders can also advantageously be used as set point value for the control process, as a result of which slight differences between the set point value and the actual value have to be compensated for and the combustion behavior can thus be adjusted quickly.

The 50% mass conversion point of the fuel conversion is preferably registered during the combustion as a characteristic variable for the control process. This characteristic variable can be determined from measurement signals of measuring sensors which project into the combustion chambers of the cylinders, by means of corresponding algorithms. Such measuring sensors can be pressure sensors or else it is possible to measure the degree of ionization in the combustion chamber by means of an ion current sensor which is particularly advantageously formed without structural work responding to the electrodes of a spark plug which is provided for the spark ignition operating mode of the internal combustion engine.

The duration of a pre-injection of fuel, which decisively influences the combustion behavior and can be precisely controlled, is preferably used as the manipulated variable for influencing the combustion behavior. The pre-injection duration can be used as the manipulated variable in both control circuits, the output value of the first control circuit forming the input value of the second control circuit. In this way, the optimum compression ignition mode for the individual cylinders can be quickly adjusted.

In particular internal combustion engines which are operated in upper load ranges in the spark ignition mode and which change the control times of the gas exchange valves for the necessary adjustment of the valve closure overlap when changing the operating modes from the compression ignition mode to the spark ignition mode, and vice versa, the control times of the gas exchange valve can be changed in the first control circuit by means of the adjustable valve drive as a manipulated variable for approximating the actual value of the manipulated variable. By changing the phase angle of the valve stroke of the output valve a global value which is close to the optimum combustion behavior can be quickly set for all cylinders, and optimization can be performed in the second control circuit with few adjustment measures.

As an alternative or addition to the measuring of the characteristic value by sensors in the combustion chamber it is also possible to measure an overall characteristic value in the first control circuit by monitoring the excess air factor in the exhaust gas with little expenditure. If, in a control process with two control circuits, the excess air factor is adjusted in the first control circuit, and the cylinders are equalized in the second control circuit, over the injection period, the cylinder settings can be optimized further by finally equalizing the operational loads of the individual cylinders in a third control circuit by matching the duration of a main injection at the respective cylinder.

Embodiments of the invention will be described below in more detail below with reference to the accompanying drawings:

### BRIEF DESCRIPTION OF THE DRAWINGS

FIG. 1 shows schematically a multi-cylinder internal combustion engine with a control unit for the compression ignition operating mode of the engine,

FIGS. 2 to 5 show alternative embodiments of first control circuits for the method according to the invention which is carried out by means of two control circuits, and

FIGS. 6 to 9 show alternative embodiments of control systems for the compression ignition mode with two control circuits.

### DESCRIPTION OF THE PREFERRED EMBODIMENTS

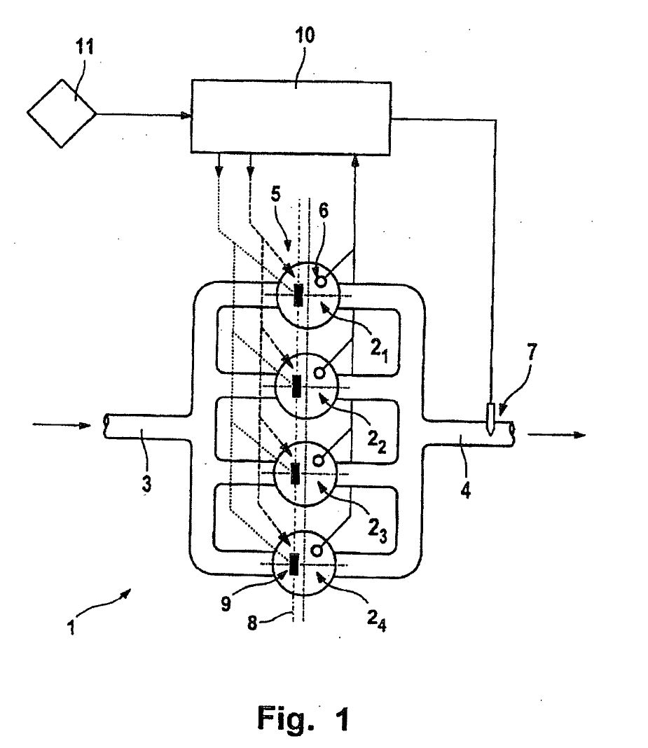

The reciprocating piston internal combustion engine 1 illustrated in FIG. 1 has four cylinders 2₁₋₄ in which fuel is mixed with combustion air and burned in order to drive the pistons. The combustion air is supplied in a known fashion via an intake manifold 3 to which all the cylinders 2₁₋₄ are connected by their inlet duct. Combustion exhaust gases are discharged from the cylinders via outlet ducts which open into an exhaust line 4 which is common to all the cylinders. In order to meter the necessary fuel to the cylinders, each cylinder 2₁₋₄ is assigned an injector 5 which injects fuel directly into the combustion chamber. The injection parameters such as start of injection, period of injection, injection duration and timing of the individual component injections are provided by a controller unit 10 as a function of the operating point of the internal combustion engine.

In order to carry out the cyclical charge change, each cylinder 2₁₋₄ has inlet valves and outlet valves which are forcibly controlled by cam shafts 8 via a valve drive 9. In the present exemplary embodiment, two cam shafts 8 are provided for controlling the inlet valves and, respectively, the outlet valves of the cylinders 2₁₋₄. The internal combustion engine 1 is operated with compression ignition at least in a wide load range. If gasoline fuel is used, a spark ignition operating mode is provided for relatively high loads, in which mode a stoichiometric mixture is formed with the fuel and the supplied combustion air and is ignited by the ignition spark of a spark plug. In the compression ignition operating mode, the combustion air is supplied unthrottled and a lean mixture is formed with the directly injected fuel. Combustion exhaust gas from the respective last cycle of the cylinder is retained in the combustion chamber by corresponding control timing of the gas exchange valves whereby the temperature level of the fresh charge is increased so that the charge auto-ignites in the subsequent compression stroke.

The valve drive 9 of the gas exchange valves can be set in a variable way such that it is possible to vary the control times. In the process, control times are set in the compression ignition mode, which are different from those in the spark ignition operating mode in order to ensure the necessary retention of the exhaust gas. The valve drive 9 is actuated by the control unit 10 and placed in the position which corresponds to the desired retention of the exhaust gases. The control unit 10 has access to a characteristic diagram memory 11 from which the operating parameters of the internal combustion engine which are to be set by the control unit for each operating point are available. The control unit controls the compression ignition operating mode of the internal combustion engine and monitors the combustion behavior in each cylinder. It is possible to intervene in the combustion behavior by changing the injection parameters and/or adjusting the cam drive. The characteristic variables for the control with full information about the actual combustion profile during the compression ignition operating mode are acquired by measuring sensors 6 which are provided in each cylinder 2₁₋₄ and project into the respective combustion chambers. As an alternative, or in addition, it is possible to acquire information about the combustion from the measurement signal of a lambda probe 7 in the exhaust line 4, which supplies the control unit 10 with information about the residual oxygen content of the exhaust gas.

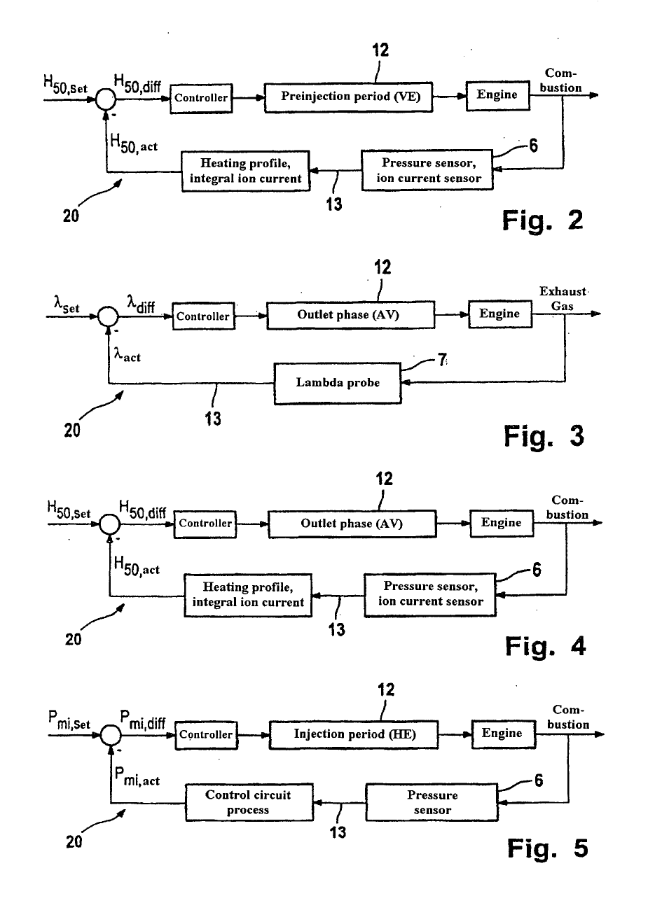

According to the invention, two control circuits are provided. An average value, derived from all the cylinders, of a characteristic variable is used in a first control circuit and is adjusted to an overall set point value which is sent to all the cylinders. Also, characteristic variables are measured at each cylinder and matched to one another in a second control circuit by means of individually determined manipulated variables. Control circuits for approximating a characteristic variable to a set point value are illustrated in FIGS. 2 to 5. The position of the 50% mass conversion points of fuel combustion in the combustion chambers is determined in FIG. 2 by the characteristic variable of the combustion process from a measurement signal which is acquired in the combustion chamber by means of a sensor 6 arranged therein. The sensor 6 can be a pressure sensor or an ion current sensor 6 from which the heating profile can be determined during the combustion process. The actual value H_{50,act} of the 50% mass conversion point is compared with a set point value which can be acquired from the characteristic diagram memory. When the actual value deviates from the set point value, the position of the mass conversion point is influenced by adapting the duration of a fuel pre-injection. Within the scope of the control process according to the invention with two control circuits, the control circuit illustrated in FIG. 2 can be used either as a first or as a second control circuit.

FIG. 3 shows a first control circuit 20 in which the excess air factor lambda in the combustion exhaust gas is measured as a characteristic variable 13 by means of a lambda probe 7 of the outlet line. When the actual value deviates from the set point value, the combustion behavior is changed by correspondingly changing a manipulated variable. The actuator in the control circuit 20 is formed by the valve drive of the gas exchange valves which can be set in a variable fashion. Preferably, the phase angle AV of the outlet valve is varied since the outlet phase has a decisive influence on the retention of exhaust gases in the combustion chamber, and thus on the combustion timing in the compression ignition mode.

FIG. 4 shows a control circuit 20 in which the phase angle AV of the outlet valve forms the manipulated variable 12, and the characteristic variable 13 in the control circuit is the 50% mass conversion point. The actual position of the mass conversion point which is to be compared with the set point value is acquired from the signal of a pressure sensor or of an ion current sensor in the combustion chamber.

FIG. 5 shows a control circuit 20 for the compression ignition operating mode of an internal combustion engine, in which mode the mean pressure of the cylinder is acquired from the signal of a pressure sensor. The mean value is approximated to a set point value in the control circuit 20, the manipulated variable 12 in the control circuit being the duration of a main injection HE of the respective cylinder. This control circuit is preferably used for equalizing the loads of all the cylinders for the cylinder-specific control according to the invention. In the process, an average value of the individual pressure sensors can be formed as a set point value of the mean pressure, and the load at the respective cylinder can be adjusted by adapting the injection period.

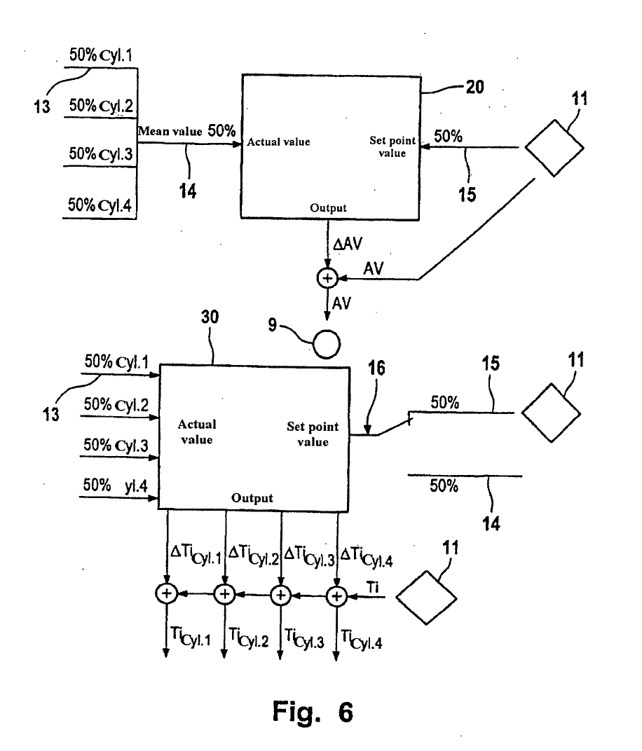

FIG. 6 shows a control process according to the invention for the compression ignition operating mode with two control circuits. The position of the 50% mass conversion point of the current fuel combustion is measured both in the first control circuit 20 and in the second control circuit 30. The first control circuit 20 corresponds here to the presentation of the control circuit in FIG. 4. Actuating measures are carried out by varying the outlet phase AV of the outlet valve. The position of the 50% mass conversion point is determined from the measurement signals of the ion current sensor in the combustion chambers, a mean value 14 of the characteristic variables being used as an actual value and supplied to the control circuit 20. The mean value 14 is compared to a overall set point value 15 which is acquired from the characteristic diagram memory 11 and is adapted by adjusting the phase angle of the outlet valve. An actuating command ΔAV to the valve drive in order to change the phase angle of the output cam shaft which is logically linked to a basic value which can be obtained from the characteristic diagram 11 as a function of the operational point of the internal combustion engine is obtained as the output value of the controller.

In the second control circuit 30, the possibly different positions of the 50% mass conversion points of the individual cylinders are equalized by adapting the actual position of the mass conversion points to a predefined set point value by adapting the duration of the fuel injection. A mean value 14 of all the measured characteristic variables can be input as a set point value in the second control circuit for the cylinder-specific adaptation, or alternatively, a basic set point value 15 is read out from the characteristic diagram 11 according to the present operating point. A change in the injection duration δTi is determined in accordance with the deviation of the measured actual values of the characteristic variable 13 of the respective cylinder as a manipulated variable 12 which is logically combined at each cylinder with a basic value for the injection duration Ti which is available from the characteristic diagram memory 11 as a function of the engine operating point.

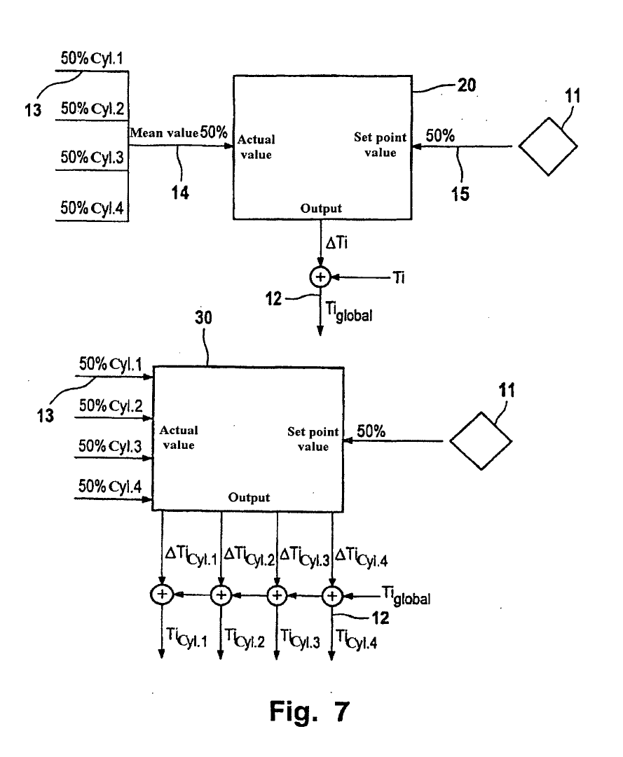

In the control strategy illustrated in FIG. 7, the pre-injection duration is used as the manipulated variable 12 in both control circuits 20, 30. In the process, in the first control circuit 20, a mean value 14 of the positions of the 50% mass conversion point is formed from the ion current signals measured as a characteristic variable 13 at each cylinder 2₁₋₄, and is fed into the control circuit 20 as an actual value. In the approximation to the set point value 15 which is acquired from the characteristic diagram memory 11, a correction value of the pre-injection duration ΔTᵢ, which is added to a basic value Tᵢ, corresponding to the operating point, of the pre-injection duration, and a global manipulated variable Ti-global is formed for all the injectors. The manipulated variable which is formed at the output of the first control circuit 20 is used as an input variable in the second control circuit. This manipulated variable is added to each correction value of the pre-injection duration, which has been determined from the respective positions of the 50% mass conversion points of the individual cylinders.

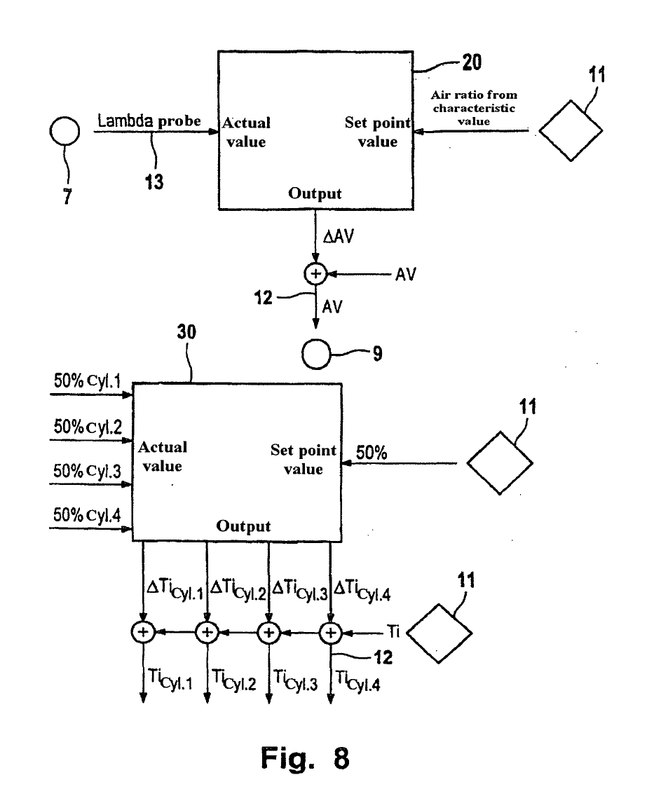

FIG. 8 shows a further possible way of controlling the compression ignition mode with two control circuits, the actual value of the air ratio being acquired in the first control circuit from the signal of the lambda probe 7 in the exhaust section. The actual value input is compared with a set point value obtained from the characteristic diagram memory 11 for the excess air factor. For the approximation to the set point value, a corrective manipulated variable for actuating the variable valve drive 11 is formed at the output of the control circuit 20. The positions of the respective 50% mass conversion points of the fuel combustion, which are determined individually at the individual cylinders, are determined in the second control circuit 30 by comparison with the set point value, acquired from the characteristic diagram 11, for the position of the 50% mass conversion point corrective manipulated variables for the pre-injection duration. The cylinder-specific correction values ΔT_{icylinder 1-cylinder 4} are logically combined with a basic value which is acquired from the characteristic diagram 11.

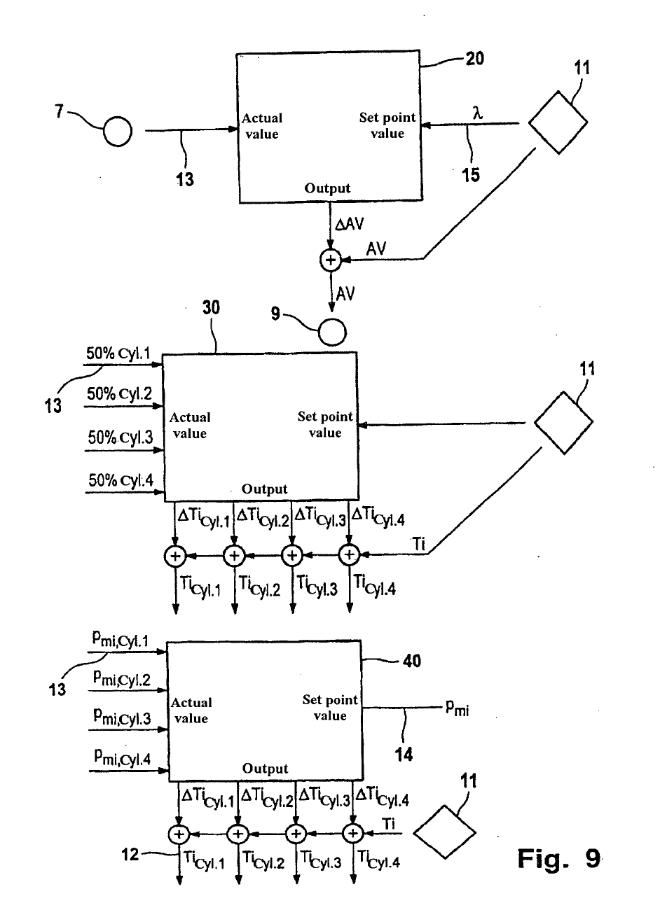

FIG. 9 shows a possible way of improving the accuracy of the approximation of the combustion positions in all the cylinders. A control structure similar to the strategy according to FIG. 8 with control of the excess air factor lambda by adjusting the phase angle of the outlet valve AV in the first control circuit and a cylinder-specific control of the 50% mass conversion point with pre-injection duration as a manipulated variable in the second control circuit is arranged downstream in a third control circuit 40. The accuracy of the equalization of all the combustion positions of the individual cylinders is achieved by equalizing the operational loads of the individual cylinders by adapting the main injection duration of the respective cylinder. In the process, in the third control circuit 40, the average cylinder pressure Pₘᵢ is determined at each cylinder and approximated to a set point value by varying the main injection duration δTᵢ as a manipulated variable, said set point value being calculated as a mean value 14 from the individual cylinder pressures. In the third control circuit which corresponds to the structure in FIG. 5, the correction values of the main injection period which are determined on a cylinder-specific basis are weighted with a basic value Ti of the main injection duration which is acquired from a characteristic diagram as a function of the momentary operating point of the internal combustion engine.

What is claimed is:

1. A method for controlling a reciprocating piston internal combustion engine (1) having a plurality of cylinders (2₁₋₄) with combustion chambers and gas exchange valves in a compression ignition operating mode in which a lean fuel/air mixture is burnt in the cylinders, comprising the steps: comparing an actual value of at least one characteristic variable (13) which is influenced by the fuel burning process with a pre-definable set point value (15) in order to form a control value (12), adjusting with the control value (12) the setting of an operating parameter (AV, TI) which acts on the mixture formation in order to approximate the actual value of the at least one characteristic variable (13) to the set point value (15), determining, based on all the cylinders (2₁₋₄), a mean value of the characteristic variables (13) in a first control circuit (20) and adjusting it to an overall set point value (15) using the control value (12), supplying the mean value to all the cylinders (2₁₋₄), and matching the characteristic variables (13) which are determined individually in a second control circuit (30) for each cylinder (2₁₋₄) to one another by the individually determined control values (12).

2. The method as claimed in claim 1, wherein, in the second control circuit (30), the set point value (15) for individually matching the characteristic variables (13) is predetermined.

3. The method as claimed in claim 1, wherein the mean value (14) of the determined characteristic variables (13) is formed in the second control circuit and is used as the set point value (15) for the control process.

4. The method as claimed in claim 1, wherein the location of the 50% mass conversion point of fuel conversion during the combustion is determined from measurement signals of measuring sensors (6) which project into the combustion chambers of the cylinders (2₁₋₄).

5. The method as claimed in claim 4, wherein ion flux sensors are provided as measuring sensors (6).

6. The method as claimed in claim 4, wherein pressure sensors are provided as measuring sensors (6).

7. The method as claimed in claim 1, wherein a duration (Ti) of a pre-injection of fuel is used as a control value (12).

8. The method as claimed in claim 7, wherein the pre-injection duration is used in both control circuits (20, 30) to form the control value (12), the output value of the first control circuit (20) forming the input value of the second control circuit (30).

9. The method as claimed in claim 1, wherein the control times (AV) of the gas exchange valve are changed as a control value (12) by means of an adjustable valve drive (9) so as to approximate the actual value of the characteristic variable (13).

10. The method as claimed in claim 9, wherein for the approximation of the characteristic variable (13) the phase angle (AV) of a valve stroke is varied.

11. The method as claimed in claim 8, wherein the valve drive (9) for the outlet valves is adjusted.

12. The method as claimed in claim 1, wherein an excess air factor (λ) in the exhaust gas is measured as the characteristic variable (13).

13. The method as claimed in claim 1, wherein a third control circuit (40) is provided, wherein operational loads of the individual cylinders are equalized by matching the durations of a main injection of fuel at the respective cylinders (2₁₋₄) by modifying the control value (12) of the second control circuit (30).
